(19) United States
(12) Patent Application Publication
(10) Pub. No.: US 2021/0140594 A1
(43) Pub. Date: May 13, 2021

(54) ILLUMINATED CHRISTMAS TREE DECORATIVE LIGHT CONTROL CIRCUIT

(71) Applicant: Ling Yung LIN, Taipei (TW)

(72) Inventor: Yan LIU, Taipei (TW)

(73) Assignee: Ling Yung LIN, Taipei (TW)

(21) Appl. No.: 17/094,995

(22) Filed: Nov. 11, 2020

(30) Foreign Application Priority Data
Nov. 12, 2019 (CN) 201921947601.8

(51) Int. Cl. F21S 4/10; A47G 33/08

(52) U.S. Cl. CPC F21S 4/10; F21W 2121/04; A47G 33/08

(57) ABSTRACT

An illuminated Christmas tree decorative light control circuit includes: a main controller and at least one branch controller. The main controller includes a main control circuit, a timing circuit, a memory circuit, a RF remote control circuit and a control output circuit capable of outputting main control signals. Each branch controller includes a signal transmission circuit capable of receiving the main control signal, a connecting terminal respectively connected to a plurality of decorative light modules (LED light string/strip equipped with a plurality of LEDs arranged linearly) installed on the Christmas tree branches, and a driving circuit arranged between the signal transmission circuit and the connecting terminal. Accordingly, the decorative light module on each tree branch can be installed independently and further connected to the corresponding branch controller, followed by connecting all of the branch controllers to a main controller. Consequently, the overall wiring is more convenient and facilitated.

### BACKGROUND OF THE INVENTION

### 1. Technical Field

The present invention relates to the technical field of a control circuit, and in particular, to an illuminated Christmas tree decorative light control circuit.

### 2. Description of Related Art

Pine or evergreen trees are often brought home to be used as part of the Christmas celebration, and it is a tradition to use ornaments, decorative lights, flower rings and ribbons etc. for the decoration of Christmas trees. In addition, to satisfy the environmental protection and energy saving demands of the modern society, decorative lights using LEDs as the light source are becoming more popular and are widely used for the decoration of Christmas trees.

Common LED decorative lights mostly combine a plurality of LED illuminating elements onto an elongated circuit in order to form a light string (light strip) having a fixed length specification (3M, 4M, 7M). In addition, to allow the light string (light strip) to have different lighting modes, typically, it is necessary to use a controller with built-in control program to control the light string (light strip), thereby allowing it to form a light strip module having various illumination changing effects (such as: flash frequency, alternating or illumination in turns etc.).

However, since most Christmas trees typically have a lot of main branches on the trunk, and each main branch can also have further termination branches extended therefrom. If one single light strip module is used to decorate a Christmas tree, since it is necessary to wrap the light strip module between the trunk and the main branches repetitively, the termination branches often cannot be decorated completely due to insufficient length of the light strip module. A feasible solution is to connect the rear end of the original light strip module to another light string (light strip) in order to extend the overall length of the light strip module to a sufficient length. Nonetheless, the length of the light strip module becomes extremely long, causing the construction work to be difficult and the overall circuit becomes messy, and the repair work during malfunction also becomes difficult.

Furthermore, if a plurality of light strip modules are jointly decorated onto one single Christmas tree, then despite that a light strip module can be installed on each relatively large main branch and the aforementioned drawback can be improved, the wiring distribution of the overall decorative light becomes relatively simple and standard. However, in terms of the actual use, since each light strip module has an independent controller, the situation where the lighting mode of each light strip module may not be controlled uniformly may occur. Moreover, the plurality of light strip modules installed can also cause the overall construction cost to increase, such that it is not economically cost effective.

### BRIEF SUMMARY OF THE INVENTION

A primary objective of the present invention is to provide an illuminated Christmas tree decorative light control circuit, which utilizes a single main controller installed at the bottom portion of the tree trunk for connecting to and controlling a plurality of branch controllers installed on each main tree branch; in addition, each branch controller is further connected to and controlling the decorative light modules (light string/light strip equipped with a plurality of LED arranged linearly) on each tree branch, such that it is optimal and suitable to the decorative light control of a Christmas tree having complicated tree branches. During the construction, each decorative light module can be installed on each tree branch independently first, followed by connecting the plurality of decorative light modules to the corresponding branch controllers respectively. Next, all of the branch controllers are connected to the main controller in order to allow the main controller to uniformly control each decorative light module via each branch controller, thereby achieving the objectives of simplified construction procedure and neatly arranged circuits.

To achieve the aforementioned objectives and technical effects, the control circuit of the present invention comprises a main controller 1 and at least one branch controller 2 electrically connected to the main controller 1. The main technical features adopted rely in: the main controller 1 comprising a main control circuit 11 and a control output circuit 16, the main control circuit 11 having a main control chip U1 arranged therein, the main control chip U1 configured to generate and output a control signal for a plurality of lighting modes via a built-in dimming control program, the control output circuit 16 configured to receive the control signal outputted by the main control circuit 11 and convert it to output a main control signal; each one of the branch controllers 2 comprising a signal transmission circuit 21, a driving circuit 22 and a connecting terminal PIN, the signal transmission circuit 21 configured to receive the main control signal outputted by the control output circuit 16, and connected to the connecting terminal PIN via the driving circuit 22 and divided into a plurality of terminal sets, thereby using each terminal set for connecting to a decorative light module 3 (light string/light strip equipped with a plurality of LEDs arranged linearly) installed on each branch of a Christmas tree, such that each decorative light module 3 is able to receive an operation control of the main controller 1 via each one of the branch controllers 2.

According to the aforementioned structure, wherein the main controller 1 further comprises: a timing circuit 13, a memory circuit 14 and a RF remote control circuit 15 connected to the main control circuit 11 respectively, the RF remote control circuit 15 configured to receive a RF wireless control signal from external in order to form an operational command inputted into the main control circuit, the timing circuit 13 configured to be operable for adjusting a running time of the main control circuit 11, the memory circuit 14 configured to store a control parameter of the built-in dimming control program of the main control chip U1.

According to the aforementioned structure, wherein the main controller 1 further comprises: an anti-reverse power source connection circuit 12 connected to the main control circuit 11; the anti-reverse power source connection circuit 12 comprising one three-terminal voltage regulator Q7 and a diode D5; the diode D5 arranged between an input end of the three-terminal voltage regulator Q7 and a main power source input end VDCin in a forward direction, such that when a polarity of an external power source connected to the main power source input end VDCin is correct, the diode D5 is conducted in order to allow the three-terminal voltage regulator Q7 to operate normally; on the contrary, when the polarity is incorrect, the diode D5 is not conducted to prevent the power source from connecting to the three-terminal voltage regulator Q7.

According to the aforementioned structure, wherein the control output circuit 16 comprises a control chip U4, a resistor R4 and an indicator lamp circuit 161; the control chip U4 is an erasable programable read only memory (EPROM) with 16 pins, a fifth pin of the control chip U4 is connected to the output end of the three-terminal voltage regulator Q7 in order to provide a power source necessary for conduction; a sixth pin, a seventh pin, an eighth pin and a ninth pin of the control chip U4 connected to a first pin, a fourteenth pin, a thirteenth pin and a twelfth pin of the main control chip U1 respectively in order to receive the control signal outputted by the main control chip U1; a tenth pin of the control chip U4 is connected to an eighth pin of the main control chip U1 via the resistor R4, a twelfth pin of the control chip U4 is connected to a ground end GND; a thirteenth pin, a fourteenth pin, a fifteenth pin and a sixteenth pin of the control chip U4 are jointly connected to a main control signal output end Scon in order to output the main control signal for controlling the branch controller 2; the indicator lamp circuit 161 comprises four indicator lamps D1, D2, D3, D4, wherein two of the indicator lamps D1, D2 are connected to each other in a forward-reverse parallel manner, and one end thereof is connected to a first pin of the control chip U4, the other two indicator lamps D3, D4 are connected to each other in a forward-reverse parallel manner, and one end thereof is connected to a second pin of the control chip U4, another end of the four indicator lamps D1, D2, D3, D4 is connected to a third pin of the control chip U4 jointly via a resistor R2, such that the timing circuit 13 is able to set various timing periods for the indicator lamps D1, D2, D3, D4 via the first pin, the second pin and third pin of the control chip U4 and the resistor R2.

According to the aforementioned structure, wherein the main power source input end VDCin is connected to an external AC power source via a power source module 10, such that the AC power source is converted to a DC power source of DC5V-36V via the power source module 10, and further connected to the main power source input end VDCin.

According to the aforementioned structure, wherein the main control chip U1 is an erasable programable read only memory (EPROM) with 14 pins; a tenth pin of the main control chip U1 is connected to an output end of the three-terminal voltage regulator Q7 via a resistor R3, and the tenth pin of the main control chip U1 is further connected to the ground end GND via a switch K1.

According to the aforementioned structure, wherein the timing circuit 13 includes two capacitors C1, C2 and a crystal oscillator JZ1, two ends of the crystal oscillator JZ1 are connected to a fifth pin and a sixth pin of the main control chip U1 respectively, and the two ends of the crystal oscillator are further connected to the ground end GND via the two capacitors C1, C2.

According to the aforementioned structure, wherein the memory circuit 14 comprises a storage chip U2 with 8 pins and a resistor R1, an eighth pin of the storage chip U2 is connected to the output end of the three-terminal voltage regulator Q7, and the eighth pin of the storage chip U2 is further connected to a third pin of the main control chip U1 and a fifth pin of the storage chip U2 respectively via the resistor R1, a sixth pin of the storage chip U2 is connected to a second pin of the main control chip U1, and a fourth pin of the storage chip U2 is connected to the ground end GND.

According to the aforementioned structure, wherein the RF remote control circuit 15 comprises a radio frequency integrated circuit chip U3 with 8 pins, two chip inductors L1, L2, five capacitors C4, C5, C6, C7, C8, a crystal oscillator JZ2 and an antenna AT; a first pin and a sixth pin of the radio frequency integrated circuit chip U3 are jointly connected to the ground end GND; a second pin and a third pin of the radio frequency integrated circuit chip U3 are jointly connected to the output end of the three-terminal voltage regulator Q7 and also jointly connected to one end of the two capacitors C4, C6 and to one end of the chip inductor L1, another end of the capacitor C4 is respectively connected to one end of the capacitor C5, one end of the chip inductor L2 and the antenna AT, another end of the capacitor C6, another end of the chip inductor L1, another end of the chip inductor L2 and another end of the capacitor C5 are jointly connected to the ground end GND respectively, a fourth pin of the radio frequency integrated circuit chip U3 is grounded via the capacitor C7, a fifth pin of the radio frequency integrated chip U3 is connected to a seventh pin of the main control chip U1, a seventh pin of the radio frequency integrated circuit chip U3 is grounded via the capacitor C8, an eighth pin of the radio frequency integrated circuit chip U3 is connected to the ground end GND via the crystal oscillator JZ2.

According to the aforementioned structure, wherein the signal transmission circuit 21 comprises: a plurality signal transmission chips U5, U6, U7, U8 connected in series, a plurality of resistors R5, R6, R7, R8, R9, R10, R11, R12, R13, R14, R15, R16, R17, R18, R19, R20, R21, R22, a plurality of capacitors C10, C11, C12, C13; each one of the signal transmission chips U5, U6, U7, U8 is a single-wire transmission three-channel LED driver control chip with 8 pins; a first pin, a second pin and a third pin of the signal transmission chip U8 are respectively connected to a branch power source input end V+ in sequence via the resistors R18, R19, R20; a fourth pin of the signal transmission chip U8 is directly connected to the ground end GND, a fifth pin of the signal transmission chip U8 is connected to a sixth pin of the signal transmission chip U7 via the resistor R16; the sixth pin of the signal transmission chip U8 is connected to a branch control signal input end Sin via the resistor R21; the branch control signal input end Sin is configured to receive the main control signal outputted by the main controller 1; an eighth pin of the signal transmission chip U8 is connected to the branch power source input end V+ via the resistor R22; the branch power source input end V+ is configured to receive a power source provided by the main controller 1, and the capacitor C13 is arranged between the first pin and the eighth pin of the signal transmission chip U8; a first pin, a second pin and a third pin of the signal transmission chip U7 are respectively connected to the branch power source input end V+ in sequence via the resistors R13, R14, R15; a fourth pin of the signal transmission chip U7 is directly connected to the ground end GND; a fifth pin of the signal transmission chip U7 is connected to a sixth pin of the signal transmission chip U6 via the resistor R12; an eighth pin of the signal transmission chip U7 is connected to the branch power source input end V+ via the resistor R17 in order to conduct to a power source required, and the capacitor C12 is arranged between the first pin and the eighth pin of the signal transmission chip U7; a first pin, a second pin and a third pin of the signal transmission chip U6 are respectively connected to the branch power source input end V+ in sequence via the resistors R9, R10, R11 in order to conduct to a power source required; a fourth pin of the signal transmission chip U6 is directly connected to the ground end GND; a fifth pin of the signal transmission chip U6 is connected to a sixth pin of the signal transmission chip U5 via the resistor R8, and the capacitor C11 is arranged between the first pin and the eighth pin of the signal transmission chip U6; a first pin, a second pin and a third pin of the signal transmission chip U5 are respectively connected to the branch power source input end V+ in sequence via the resistors R5, R6, R7 in order to conduct to a power source required; a fourth pin of the signal transmission chip U5 is directly connected to the ground end GND; the fifth pin of the signal transmission chip U5 is connected to a branch control signal output end Sout; the branch control signal output end Sout is configured to be connected to another branch controller 2 and to provide a control signal required; the capacitor C10 is arranged between the first pin and the eighth pin of the signal transmission chip U5.

According to the aforementioned structure, wherein the driving circuit 22 comprises: a plurality driving chips U9, U10, U11, U12, U13, a plurality of resistors R23, R24, R25, R26, R27; each one of the driving chips U9, U10, U11, U12, U13 is a two-way driving control chip with 8 pins; first pins of the driving chips U9, U10, U11, U12, U13 are respectively connected to a branch power source input end V+ in order to conduct to a power source required; third pins and seventh pins of the driving chips U9, U10, U11, U12, U13 are respectively connected to a ground end GND; a second pin and a fourth pin of the driving chip U13 are connected to a first pin and a second pin of the connecting terminal PIN via the resistor R27 in order to form a first terminal set provided for connecting to each one of the decorative light modules 3; a fifth pin and an eighth pin of the driving chip U13 are respectively connected to a first pin and a second pin of the signal transmission chip U8, thereby receiving signals from the signal transmission chip U8 to drive the decorative light module 3 connected to the first terminal set of the connecting terminal PIN; a second pin and a fourth pin of the driving chip U12 are connected to a third pin and a fourth pin of the connecting terminal PIN via the resistor R26 in order to form a second terminal set provided for connecting to each one of the decorative light modules 3; a fifth pin of the driving chip U12 is connected to a third pin of the signal transmission chip U8, an eighth pin of the driving chip U12 is connected to a first pin of the signal transmission chip U7, thereby receiving signals from the signal transmission chips U7, U8 respectively in order to drive the decorative light module 3 connected to the second terminal set of the connecting terminal PIN; a second pin and a fourth pin of the driving chip U11 are connected to a fifth pin and a sixth pin of the connecting terminal PIN via the resistor R25 in order to form a third terminal set provided for connecting to each one of the decorative light modules 3; a fifth pin and an eighth pin of the driving chip U11 are respectively connected to a second pin and a third pin of the signal transmission chip U7, thereby receiving signals from the signal transmission chip U7 in order to drive the decorative light module 3 connected to the third terminal set of the connecting terminal PIN; a second pin and a fourth pin of the driving chip U10 are connected to a seventh pin and an eighth pin of the connecting terminal PIN via the resistor R24 in order to form a fourth terminal set provided for connecting to each one of the decorative light modules 3; a fifth pin and an eighth pin of the driving chip U10 are respectively connected to a second pin and a third pin of the signal transmission chip U6, thereby receiving signals from the signal transmission chip U6 in order to drive the decorative light module 3 connected to the fourth terminal set connected to the connecting terminal PIN; a second pin and a fourth pin of the driving chip U9 are connected to a ninth pin and a tenth pin of the connecting terminal PIN via the resistor R23 in order to form a fifth terminal set provided for connecting to each one of the decorative light modules 3; a fifth pin and an eighth pin of the driving chip U9 are respectively connected to a first pin and a second pin of the signal transmission chip U5, thereby receiving signals from the signal transmission chip U5 in order to drive the decorative light module 3 connected to the fifth terminal set of the connecting terminal PIN.

In comparison of the currently existing techniques, the advantages of the present invention include:

1. One single main controller is used to connect to and to control a plurality of branch controllers, and each branch controller is further connected to and controlling a plurality of decorative light modules respectively, thereby creating a completely modularized and integrated structure. Therefore, the overall wiring structure and construction procedure can be simplified. In addition, since each decorative light module has its independent wiring, in case of any malfunction, the connection portion of the decorative light module and its branch controller can be identified easily and swiftly in order to perform repair or replacement of the damaged decorative light module without any changes or adjustments to other decorative light modules. As a result, the repair procedure is simplified and the cost of use is reduced.

2. For the main controller, the quantity of the branch controllers can be additionally increased depending upon the needs directly. In addition, with the increase of the quantity of the branch controllers, the quantity of the decorative light module connected thereto can be increased. Furthermore, since all of the decorative light modules are jointly connected to and controlled by the main controller, during the use, the overall scale of the decorative light can be expanded depending upon the customized needs; as a result, it can have a relatively broader applicable scope.

3. The main controller includes an anti-reverse power source connection circuit capable of preventing reverse connection of power source, a memory circuit capable of storing control parameters operated and a RF remote circuit capable of remotely operating the main controller from the external, such that the convenience and safety of use are increased.

To further explain the aforementioned objectives, technical effects and characteristics of the present invention, please refer to the illustrations of the following accompanied drawings:

### BRIEF DESCRIPTION OF THE SEVERAL VIEWS OF THE DRAWINGS

FIG. 1 is a block diagram of the main circuit structure of the present invention;

FIG. 2 is a circuit diagram of the main controller of the present invention;

FIG. 3 is a circuit diagram of the branch controller of the present invention; and

FIG. 4 is a circuit diagram illustrating the main controller connected to a plurality of branch controllers with each other of the present invention.

### DETAILED DESCRIPTION OF THE INVENTION

Please refer to FIG. 1 to FIG. 3. From the drawings, it can be understood that the structure of the present invention mainly comprises: a controller 1, at least one branch controller 2 and a plurality decorative light modules 3 (light string/light strip equipped with a plurality of LEDs arranged linearly); wherein the main controller 1 is mainly formed by a main control circuit 11, an anti-reverse power source connection circuit 12, a timing circuit 13, a memory circuit, a RF remote control 15 and a control output circuit 16.

The anti-reverse power source connection circuit 12 includes a three-terminal voltage regulator Q7, a capacitor C3 and a diode D5; wherein the capacitor C3s arranged between the output end (third pin) of the three-terminal voltage regulator Q7 and the ground end GND (second pin), the diode D5 is arranged between the input end (first pin) of the three-terminal voltage regulator Q7 and a main power source input end VDCin in a forward direction. When the polarity of the external power source connected to the main power source input end VDCin is correct, the diode D5 is conducted in order to allow the three-terminal voltage regulator Q7 to operate normally. On the contrary, if the polarity is incorrect, the diode D5 is not conducted to prevent the power source from connecting to the three-terminal voltage regulator Q7, such that the protection effect capable of preventing the main control chip U1 from being punctured can be achieved.

During the actual application, if a conventional grid AC power source (AC 100-240V) is used, then the AC power source can pass through a power source module 10 (power adapter) for rectification and filter in order to convert it into a DC power source (DC 5V-36V), followed which the main power source input end VDCin is connected to the main controller 1 for conduction. The main power source input end VDCin can be directly connected to a main power source output end VDCout, and two ground ends GND connected to each other can be arranged at one side of the corresponding main power source input end VDCin and the main power source output end VDCout respectively. The main power source output end VDCout and the ground end GND can be used to form a branch power supply end capable of providing the power source necessary for the branch controller 2.

The main control circuit 11 includes a main control chip U1, a resistor R3 and a switch K1; wherein the main control chip U1 is an erasable programable read only memory (EPROM) with 14 pins and equipped with a built-in dimming function in order to control and generate various different lighting modes via a built-in control program (the use of a control program in the main control chip U1 is an a known technique commonly used). The fourth pin of the main control chip U1 is connected to the output end (third pin) of the three-terminal voltage regulator Q7 in order to conduct a working voltage of DC 36V. The resistor R3 is arranged between the fourth pin and the tenth pin of the main control chip U1, and the tenth pin of the main control chip U1 is grounded via the switch K1.

The timing circuit 13 includes: two capacitors C1, C2 and a crystal oscillator JZ1; wherein two ends of the crystal oscillator are connected to the fifth pin and the sixth pin of the main control chip U1 respectively, and the two ends of the crystal oscillator JZ1 are further grounded via the capacitors C1, C2 respectively, thereby forming a timing mechanism connected to the main control chip U1.

The memory circuit 14 comprises a storage chip U2 with 8 pins and a resistor R1; wherein the eighth pin of the storage chip U2 is connected to the output end (third pin) of the three-terminal voltage regulator Q7 in order to connect to the required power source. In addition, the eighth pin of the storage chip U2 is jointly connected to the third pin of the main control chip U1 and the fifth pin of the storage pin U2 via the resistor R1, the sixth pin of the storage chip U2 is connected to the second pin of the main control chip U1, and the fourth pin of the storage chip U2 is grounded. Accordingly, the storage chip U2 is able to store various operational setting parameters of the main control chip U1, and during the restoration of power supply after power shutdown, it is able to recover various functions already set before the power shutdown.

The RF remote control circuit 15 comprises a radio frequency integrated circuit chip U3 with 8 pins, two chip inductors L1, L2, capacitors C4, C5, C6, C7, C8, a crystal oscillator JZ2 and an antenna AT; wherein the first pin and the sixth pin of the radio frequency integrated circuit chip U3 are grounded jointly, the second pin and third pin of the radio frequency integrated circuit chip U3 are jointly connected to the output end (third pin) of the three-terminal voltage regulator Q7 and are also jointly connected to one end of the capacitors C4, C6 and the chip inductor L1; another end of the capacitor C4 is connected to one end of the capacitor C5, one end of the chip inductor L2 and the antenna AT respectively; another end of the capacitor C6 is respectively connected to another end of the chip inductor L1, another end of the chip inductor L2, another end of the capacitor C5 and jointly connected to the ground; the fourth pin of the radio frequency integrated circuit chip U3 is grounded via the capacitor C7; the fifth pin of the radio frequency integrated circuit chip U3 is connected to the seventh pin of the main control chip U1; the seventh pin of the radio frequency integrated circuit chip U3 is grounded via the capacitor C8; the eighth pin of the radio frequency integrated circuit chip U3 is grounded via the crystal oscillator JZ2. Accordingly, after the antenna AT receives an external RF control remote signal, the signal is amplified via the chip inductors L1, L2 and the capacitors C4, C5, C6, following which it is inputted into the radio frequency integrated circuit chip U3. After the signal is converted into an operational command by the radio frequency integrated circuit chip U3, it is transmitted to the main control chip U1 to perform the subsequent control and adjustment actions.

The control output circuit 16 includes a control chip U4, a resistor R4 and an indicator lamp circuit 161 connected to the control chip U4. The control chip U4 is an erasable programable read only memory (EPROM) with 16 pins, and its fifth pin is connected to the output end (third pin) of the three-terminal voltage regulator Q7 in order to conduct the required power source. The sixth pin, seventh pin, eighth pin and ninth pin of the control chip U4 are respectively connected to the first pin, fourteenth pin, thirteenth pin and twelfth pin of the main control chip U1 in order to receive the control signal outputted by the main control chip U1. The tenth pin of the control chip U4 is connected to the eighth pin of the main control chip U1 via the resistor R4, and the twelfth pin of the control chip U4 is grounded. The thirteenth pin, the fourteenth pin, fifteenth pin and sixteenth pin of the control chip U4 are jointly connected to a main control signal output end Scon in order to provide a main control signal necessary for the subsequent actions of the branch controller 2.

The indicator lamp circuit 161 comprises: two indicator lamps D1, D2 (can be LEDs) connected in a forward-reverse parallel manner and having one end connected to the first pin of the control chip U4 respectively, two indicator lamps D3, D4 (can be LEDs) connected in a forward-reverse parallel manner and having one end connected to the second pin of the control chip U4 respectively. Other ends of the indicator lamps D1, D2, D3 and D4 are jointly connected to the third pin of the control chip U4 via the resistor R2, thereby allowing the timing circuit 13 to set various timing periods for the indicator lamps D1, D2, D3 and D4 via the first pin, second pin, third pin of the control chip U4 and the resistor R2.

The branch controller 2 comprises: a signal transmission circuit 21 and a driving circuit 22; wherein the signal transmission circuit 21 includes a plurality of signal transmission chips U5, U6, U7, U8 connected in series, resistors R5˜R22 and capacitors C10˜C13.

The first pin, second pin and the third pin of the signal transmission chip U8 are directly connected to a branch power source input end V+ via the resistors R18, R19, R20 respectively in sequence, and the fourth pin of the signal transmission chip U8 is directly connected to a ground end GND. The fifth pin of the signal transmission chip U8 is connected to the sixth pin of the signal transmission chip U7 via the resistor R16. The sixth pin of the signal transmission chip U8 is connected to a branch control signal input end Sin via the resistor R21, and the branch control signal input end Sin is connected to the main control signal output end Scon of the main controller 1 in order to receive the main control signal outputted from the main controller 1. The eighth pin of the signal transmission chip U8 is connected to the branch power source input end V+ via the resistor R22, and the branch power source input end V+ is connected to the main power source output end VDCout (branch power supply end) of the main controller 1 in order to receive the power supplied from the main controller 1. In addition, the capacitor C13 is arranged between the first pin and the eighth pin of the signal transmission chip U8.

The first pin, second pin and the third pin of the signal transmission chip U7 are respectively connected to the branch power source input end V+ in sequence via the resistors R13, R14, R15. The fourth pin of the signal transmission chip U7 is directly connected to the ground end GND. The fifth pin of the signal transmission chip U7 is connected to the sixth pin of the signal transmission chip U6 via the resistor R12. The eighth pin of the signal transmission chip U7 is connected to the branch power source input end V+ via the resistor R17 in order to conduct the required power source. In addition, the capacitor C12 is arranged between the first pin and the eighth pin of the signal transmission chip U7.

The first pin, second pin and third pin of the signal transmission chip U6 are respectively connected to the branch power source input end V+ in sequence via the resistors R9, R10, R11 in order to conduct the required power source. The fourth pin of the signal transmission chip U6 is directly connected to the ground end GND. The fifth pin of the signal transmission chip U6 is connected to the sixth pin of the signal transmission chip U5 via the resistor R8. The capacitor C11 is arranged between the first pin and the eighth pin of the signal transmission chip U6.

The first pin, second pin and third pin of the signal transmission chip U5 are respectively connected to the branch power source input end V+ in sequence via the resistors R5, R6, R7 in order to conduct the required power source. The fourth pin of the signal transmission chip U6 is directly connected to the ground end GND. The fifth pin of the signal transmission chip U6 is connected to a branch control signal output end Sout. The branch control signal output end Sout is configured to be connected to another branch controller 2 and to provide a control signal required. The capacitor C10 is arranged between the first pin and the eighth pin of the signal transmission chip U5.

The driving circuit 22 includes: driving chips U9˜U13, resistors R23˜R27 and a connecting terminal PIN. The first pins of the driving chips U9, U10, U11, U12, U13 are connected to the branch power source input end V+ respectively in order to conduct the power source required. The third pin and seventh pin of the driving chips U9, U10, U11, U12, U13 are connected to the ground end GND respectively.

The second pin and fourth pin of the driving chip U13 are connected to the first pin and second pin of the connecting terminal PIN via the resistor R27 in order to form a first terminal set provided for connecting to an external decorative light modules 3 (LED light string/light strip). The fifth pin and eighth pin of the driving chip U13 are connected to the first pin and the second pin of the signal transmission chip U8 in order to receive signals from the signal transmission chip U8 and to control the decorative light module 3 connected to the first terminal set (first pin and second pin) of the connecting terminal PIN.

The second pin and fourth pin of the driving chip U12 are connected to a third pin and a fourth pin of the connecting terminal PIN via the resistor R26 in order to form a second terminal set provided for connecting to an external decorative light modules 3 (LED light string/light strip). The fifth pin of the driving chip U12 is connected to the third pin of the signal transmission chip U8. The eighth pin of the driving chip U12 is connected to the first pin of the signal transmission chip U7, thereby receiving signals from the signal transmission chips U7, U8 respectively in order to drive the decorative light module 3 connected to the second terminal set (third pin and fourth pin) of the connecting terminal PIN.

The second pin and fourth pin of the driving chip U11 are connected to the fifth pin and sixth pin of the connecting terminal PIN via the resistor R25 in order to form a third terminal set provided for connecting to an external decorative light modules 3 (LED light string/light strip). The fifth pin and eighth pin of the driving chip U11 are respectively connected to the second pin and third pin of the signal transmission chip U7 in sequence, thereby receiving signals from the signal transmission chip U7 in order to control the decorative light module 3 connected to the third terminal set (fifth pin and sixth pin) of the connecting terminal PIN.

The second pin and fourth pin of the driving chip U10 are connected to the seventh pin and eighth pin of the connecting terminal PIN via the resistor R24 in order to form a fourth terminal set provided for connecting to an external decorative light module 3 (LED light string/light strip). The fifth pin and eighth pin of the driving chip U10 are respectively connected to the second pin and third pin of the signal transmission chip U6 in sequence, thereby receiving signals from the signal transmission chip U6 in order to control the decorative light module 3 connected to the fourth terminal set (seventh pin and eighth pin) connected to the connecting terminal PIN.

The second pin and fourth pin of the driving chip U9 are connected to the ninth pin and tenth pin of the connecting terminal PIN via the resistor R23 in order to form a fifth terminal set provided for connecting to an external decorative light modules 3 (LED light string/light strip). The fifth pin and eighth pin of the driving chip U9 are respectively connected to the first pin and second pin of the signal transmission chip U5 in sequence, thereby receiving signals from the signal transmission chip U5 in order to drive the decorative light module 3 connected to the fifth terminal set (ninth pin and tenth pin) of the connecting terminal PIN.

Through the aforementioned connection method of connecting each one of the signal transmission chips U5, U6, U7, U8 with each other, the main control signal inputted by the branch control signal input end Sin can be inputted from the fifth pin of the signal transmission chip U8, followed by respectively transmitting to the signal transmission chips U7, U6, U5 in sequence. Then, the driving circuit 22 is able to drive each set of the decorative light modules 3 connected to the connecting terminal PIN respectively.

As shown in FIG. 4, it can be understood that during the actual application of the aforementioned structure of the present invention, a plurality of branch controllers 2 of an appropriate quantity can be installed according to the energy supplied by the power supply and the demanded quantity of the decorative light modules 3 (LED light strings/light strips) desired to be installed on each tree branch of the Christmas tree, such that each of the decorative light modules 3 is connected to each one of the branch controller 2 respectively, following which a main controller 1 is used for connecting to the plurality of branch controllers 2 in series in order to control such branch controllers. The configuration method is as follows:

The main power source output end VDCout (branch power supply end) of the main controller 1 is connected to the branch power source input end V+ of each one of the branch controller 2 respectively, and the ground end GND of the main controller 1 is connected to the ground end GND of each one of the branch controllers 2 respectively, in order to provide the power source necessary for each one of the branch controllers 2. The main control signal output end Scon of the main controller 1 is connected to the branch control signal input tend Sin of one of the branch controllers 2 (referred to as the first branch controller 2), in order to transmit a main control signal outputted by the main controller 1 to the (first) branch controller 2. At the same time, the branch control signal output end Sout of the (first) branch controller 2 is connected to the branch control signal input end Sin of another branch controller 2 (referred to as the second branch controller 2). Consequently, through such connection method of connecting the branch control signal output end Sout of different branch controller 2 to another branch control signal input end Sin, a decorative light structure having one single main controller 1 connected to and controlling a plurality of light decorative modules 3 (LED light strings/light strips) via a plurality of branch controllers 2 can be assembled and achieved.

In the aforementioned structure of the present invention, each branch controller 2 can use the connecting terminal PIN for connecting to a plurality of decorative light modules 3 (LED light strings/light strips) installed on each tree branch, and the quantity of the branch controllers 2 and the quantities of the signal transmission circuits 21 and driving circuits 22 in each branch controller 2 can be expanded depending upon the actual condition. The control output circuit 16 of the main controller 1 sends out the main control signal via the main control signal output end Scon, and the signal transmission circuit 21 of a branch controller 2 then receives the main control signal via the branch control signal input end Sin, and the signal is further transmitted to the driving circuit 22. The driving circuit 22 then uses different driving chips U9˜U13 to jointly control the actions of the light decorative modules 3 via the connecting terminal PIN. Accordingly, with such structure, each one of the decorative light modules 3 on each one of the tree branches of the Christmas tree can be prevented from interfering with each other, and during any malfunction, inspection and repair can be performed easily. Furthermore, the light decorative modules 3 on different tree branches can also have their own independent wiring during the installation, followed by integrating the circuits together onto the connecting terminal PIN of the branch controller 2. Finally, all of the branch controllers 2 are connected to a main controller 1 in order to allow the main controller 1 to perform uniform control, and the overall circuits are neatly arranged.

What is claimed is:

1. An illuminated Christmas tree decorative light control circuit, comprising: a main controller (1) and at least one branch controller (2) electrically connected to the main controller (1); characterized in that: the main controller (1) comprising a main control circuit (11) and a control output circuit (16), the main control circuit (11) having a main control chip (U1) arranged therein, the main control chip (U1) configured to generate and output a control signal for a plurality of lighting modes via a built-in dimming control program, the control output circuit (16) configured to receive the control signal outputted by the main control circuit (11) and convert it to output a main control signal; each one of the branch controllers (2) comprising a signal transmission circuit (21), a driving circuit (22) and a connecting terminal (PIN), the signal transmission circuit (21) configured to receive the main control signal outputted by the control output circuit (16), and connected to the connecting terminal (PIN) via the driving circuit (22) and divided into a plurality of terminal sets, thereby using each terminal set for connecting to a decorative light module (3) installed on each branch of a Christmas tree, such that each decorative light module (3) is able to receive an operation control of the main controller (1) via each one of the branch controllers (2).

2. The illuminated Christmas tree decorative light control circuit according to claim 1, wherein the main controller (1) further comprises: a timing circuit (13), a memory circuit (14) and a RF remote control circuit (15) connected to the main control circuit (11) respectively, the RF remote control circuit (15) configured to receive a RF wireless control signal from external in order to form an operational command inputted into the main control circuit (11), the timing circuit (13) configured to be operable for adjusting a running time of the main control circuit (11), the memory circuit (14) configured to store a control parameter of the built-in dimming control program of the main control chip (U1).

3. The illuminated Christmas tree decorative light control circuit according to claim 2, wherein the main controller (1) further comprises: an anti-reverse power source connection circuit (12) connected to the main control circuit (11); the anti-reverse power source connection circuit (12) comprising one three-terminal voltage regulator (Q7) and a diode (D5); the diode (D5) arranged between an input end of the three-terminal voltage regulator (Q7) and a main power source input end (VDCin) in a forward direction, such that when a polarity of an external power source connected to the main power source input end (VDCin) is correct, the diode (D5) is conducted in order to allow the three-terminal voltage regulator (Q7) to operate normally; on the contrary, when the polarity is incorrect, the diode (D5) is not conducted to prevent the power source from connecting to the three-terminal voltage regulator (Q7).

4. The illuminated Christmas tree decorative light control circuit according to claim 3, wherein the control output circuit (16) comprises a control chip (U4), a resistor (R4) and an indicator lamp circuit (161); the control chip (U4) is an erasable programable read only memory with 16 pins, a fifth pin of the control chip (U4) is connected to the output end of the three-terminal voltage regulator (Q7) in order to provide a power source necessary for conduction; a sixth pin, a seventh pin, an eighth pin and a ninth pin of the control chip (U4) connected to a first pin, a fourteenth pin, a thirteenth pin and a twelfth pin of the main control chip (U1) respectively in order to receive the control signal outputted by the main control chip (U1); a tenth pin of the control chip (U4) is connected to an eighth pin of the main control chip (U1) via the resistor (R4), a twelfth pin of the control chip (U4) is connected to a ground end (GND); a thirteenth pin, a fourteenth pin, a fifteenth pin and a sixteenth pin of the control chip (U4) are jointly connected to a main control signal output end (Scon) in order to output the main control signal for controlling the branch controller (2); the indicator lamp circuit (161) comprises four indicator lamps (D1, D2, D3, D4), wherein two of the indicator lamps (D1, D2) are connected to each other in a forward-reverse parallel manner, and one end thereof is connected to a first pin of the control chip (U4), the other two indicator lamps (D3, D4) are connected to each other in a forward-reverse parallel manner, and one end thereof is connected to a second pin of the control chip (U4), another end of the four indicator lamps (D1, D2, D3, D4) is connected to a third pin of the control chip (U4) jointly via a resistor (R2), such that the timing circuit (13) is able to set various timing periods for the indicator lamps (D1, D2, D3, D4) via the first pin, the second pin and third pin of the control chip (U4) and the resistor (R2).

5. The illuminated Christmas tree decorative light control circuit according to claim 3, wherein the main power source input end (VDCin) is connected to an external AC power source via a power source module (10), such that the AC power source is converted to a DC power source of DC5V-36V via the power source module (10), and further connected to the main power source input end (VDCin).

6. The illuminated Christmas tree decorative light control circuit according to claim 4, wherein the main control chip (U1) is an erasable programable read only memory with 14 pins; a tenth pin of the main control chip (U1) is connected to an output end of the three-terminal voltage regulator (Q7) via a resistor (R3), and the tenth pin of the main control chip (U1) is further connected to the ground end (GND) via a switch (K1).

7. The illuminated Christmas tree decorative light control circuit according to claim 6, wherein the timing circuit (13) includes two capacitors (C1, C2) and a crystal oscillator (JZ1), two ends of the crystal oscillator (JZ1) are connected to a fifth pin and a sixth pin of the main control chip (U1) respectively, and the two ends of the crystal oscillator are further connected to the ground end (GND) via the two capacitors (C1, C2).

8. The illuminated Christmas tree decorative light control circuit according to claim 6, wherein the memory circuit (14) comprises a storage chip (U2) with 8 pins and a resistor (R1), an eighth pin of the storage chip (U2) is connected to the output end of the three-terminal voltage regulator (Q7), and the eighth pin of the storage chip (U2) is further connected to a third pin of the main control chip (U1) and a fifth pin of the storage chip (U2) respectively via the resistor (R1), a sixth pin of the storage chip (U2) is connected to a second pin of the main control chip (U1), and a fourth pin of the storage chip (U2) is connected to the ground end (GND).

9. The illuminated Christmas tree decorative light control circuit according to claim 6, wherein the RF remote control circuit (15) comprises a radio frequency integrated circuit chip (U3) with 8 pins, two chip inductors (L1, L2), five capacitors (C4, C5, C6, C7, C8), a crystal oscillator (JZ2) and an antenna (AT); a first pin and a sixth pin of the radio frequency integrated circuit chip (U3) are jointly connected to the ground end (GND); a second pin and a third pin of the radio frequency integrated circuit chip (U3) are jointly connected to the output end of the three-terminal voltage regulator (Q7) and also jointly connected to one end of the two capacitors (C4, C6) and to one end of the chip inductor (L1), another end of the capacitor (C4) is respectively connected to one end of the capacitor (C5), one end of the chip inductor (L2) and the antenna (AT), another end of the capacitor (C6), another end of the chip inductor (L1), another end of the chip inductor (L2) and another end of the capacitor (C5) are jointly connected to the ground end (GND) respectively, a fourth pin of the radio frequency integrated circuit chip (U3) is grounded via the capacitor (C7), a fifth pin of the radio frequency integrated chip (U3) is connected to a seventh pin of the main control chip (U1), a seventh pin of the radio frequency integrated circuit chip (U3) is grounded via the capacitor (C8), an eighth pin of the radio frequency integrated circuit chip (U3) is connected to the ground end (GND) via the crystal oscillator (JZ2).

10. The illuminated Christmas tree decorative light control circuit according to claim 1, wherein the signal transmission circuit (21) comprises: a plurality signal transmission chips (U5, U6, U7, U8) connected in series, a plurality of resistors (R5, R6, R7, R8, R9, R10, R11, R12, R13, R14, R15, R16, R17, R18, R19, R20, R21, R22), a plurality of capacitors (C10, C11, C12, C13); each one of the signal transmission chips (U5, U6, U7, U8) is a single-wire transmission three-channel LED driver control chip with 8 pins; a first pin, a second pin and a third pin of the signal transmission chip (U8) are respectively connected to a branch power source input end (V+) in sequence via the resistors (R18, R19, R20); a fourth pin of the signal transmission chip (U8) is directly connected to the ground end (GND), a fifth pin of the signal transmission chip (U8) is connected to a sixth pin of the signal transmission chip (U7) via the resistor (R16); the sixth pin of the signal transmission chip (U8) is connected to a branch control signal input end (Sin) via the resistor (R21); the branch control signal input end (Sin) is configured to receive the main control signal outputted by the main controller (1); an eighth pin of the signal transmission chip (U8) is connected to the branch power source input end (V+) via the resistor (R22); the branch power source input end (V+) is configured to receive a power source provided by the main controller (1), and the capacitor (C13) is arranged between the first pin and the eighth pin of the signal transmission chip (U8); a first pin, a second pin and a third pin of the signal transmission chip (U7) are respectively connected to the branch power source input end (V+) in sequence via the resistors (R13, R14, R15); a fourth pin of the signal transmission chip (U7) is directly connected to the ground end (GND); a fifth pin of the signal transmission chip (U7) is connected to a sixth pin of the signal transmission chip (U6) via the resistor (R12); an eighth pin of the signal transmission chip (U7) is connected to the branch power source input end (V+) via the resistor (R17) in order to conduct to a power source required, and the capacitor (C12) is arranged between the first pin and the eighth pin of the signal transmission chip (U7); a first pin, a second pin and a third pin of the signal transmission chip (U6) are respectively connected to the branch power source input end (V+) in sequence via the resistors (R9, R10, R11) in order to conduct to a power source required; a fourth pin of the signal transmission chip (U6) is directly connected to the ground end (GND); a fifth pin of the signal transmission chip (U6) is connected to a sixth pin of the signal transmission chip (U5) via the resistor (R8), and the capacitor (C11) is arranged between the first pin and the eighth pin of the signal transmission chip (U6); a first pin, a second pin and a third pin of the signal transmission chip (U5) are respectively connected to the branch power source input end (V+) in sequence via the resistors (R5, R6, R7) in order to conduct to a power source required; a fourth pin of the signal transmission chip (U5) is directly connected to the ground end (GND); the fifth pin of the signal transmission chip (U5) is connected to a branch control signal output end (Sout); the branch control signal output end (Sout) is configured to be connected to another branch controller (2) and to provide a control signal required; the capacitor (C10) is arranged between the first pin and the eighth pin of the signal transmission chip (U5).

11. The illuminated Christmas tree decorative light control circuit according to claim 10, wherein the driving circuit (22) comprises: a plurality driving chips (U9, U10, U11, U12, U13), a plurality of resistors (R23, R24, R25, R26, R27); each one of the driving chips (U9, U10, U11, U12, U13) is a two-way driving control chip with 8 pins; the first pins of the driving chips (U9, U10, Ulf, U12, U13) are respectively connected to a branch power source input end (V+) in order to conduct to a power source required; the third pins and seventh pins of the driving chips (U9, U10, U11, U12, U13) are respectively connected to a ground end (GND); a second pin and a fourth pin of the driving chip (U13) are connected to a first pin and a second pin of the connecting terminal (PIN) via the resistor (R27) in order to form a first terminal set provided for connecting to each one of the decorative light modules (3); a fifth pin and an eighth pin of the driving chip (U13) are respectively connected to a first pin and a second pin of the signal transmission chip (U8), thereby receiving signals from the signal transmission chip (U8) to drive the decorative light module (3) connected to the first terminal set of the connecting terminal (PIN); a second pin and a fourth pin of the driving chip (U12) are connected to a third pin and a fourth pin of the connecting terminal (PIN) via the resistor (R26) in order to form a second terminal set provided for connecting to each one of the decorative light modules (3); a fifth pin of the driving chip (U12) is connected to a third pin of the signal transmission chip (U8), an eighth pin of the driving chip (U12) is connected to a first pin of the signal transmission chip (U7), thereby receiving signals from the signal transmission chips (U7, U8) respectively in order to drive the decorative light module (3) connected to the second terminal set of the connecting terminal (PIN); a second pin and a fourth pin of the driving chip (U11) are connected to a fifth pin and a sixth pin of the connecting terminal (PIN) via the resistor (R25) in order to form a third terminal set provided for connecting to each one of the decorative light modules (3); a fifth pin and an eighth pin of the driving chip (U11) are respectively connected to a second pin and a third pin of the signal transmission chip (U7), thereby receiving signals from the signal transmission chip (U7) in order to drive the decorative light module (3) connected to the third terminal set of the connecting terminal (PIN); a second pin and a fourth pin of the driving chip (U10) are connected to a seventh pin and an eighth pin of the connecting terminal (PIN) via the resistor (R24) in order to form a fourth terminal set provided for connecting to each one of the decorative light module (3); a fifth pin and an eighth pin of the driving chip (U10) are respectively connected to a second pin and a third pin of the signal transmission chip (U6), thereby receiving signals from the signal transmission chip (U6) in order to drive the decorative light module (3) connected to the fourth terminal set connected to the connecting terminal (PIN); a second pin and a fourth pin of the driving chip (U9) are connected to a ninth pin and a tenth pin of the connecting terminal (PIN) via the resistor (R23) in order to form a fifth terminal set provided for connecting to each one of the decorative light modules (3); a fifth pin and an eighth pin of the driving chip (U9) are respectively connected to a first pin and a second pin of the signal transmission chip (U5), thereby receiving signals from the signal transmission chip (U5) in order to drive the decorative light module (3) connected to the fifth terminal set of the connecting terminal (PIN).
